(19) United States
(12) Patent Application Publication
(10) Pub. No.: US 2018/0079188 A1
(43) Pub. Date: Mar. 22, 2018

(54) Recyclable Polyethylene Film

(71) Applicant: Constantia Hueck Folien GmbH & Co. KG, Pirk (DE)

(72) Inventors: Achim Grefenstein, Altrip (DE); Stefan Büttner, Neumarkt i. d. Oberpf. (DE); Ingo Geillersdörfer, Mantel (DE)

(21) Appl. No.: 15/562,132

(22) PCT Filed: Mar. 29, 2016
(86) PCT No.: PCT/EP2016/056767

§ 371 Date: Sep. 27, 2017

(30) Foreign Application Priority Data
Mar. 27, 2015 (AT) A 50249/2015

(51) Int. Cl. B32B 27/08; B32B 27/32

(52) U.S. Cl. CPC B32B 27/08; B32B 27/32; B32B 27/327; B32B 2307/306; B32B 2309/105; B32B 2307/51; B32B 2307/518

(57) ABSTRACT

A recyclable polyethylene film has at least 80% polyethylene material and max. 20% compatible polyolefin material. The polyethylene film has a central layer of linear low-density polyethylene (LLDPE) and/or metallocene linear low-density polyethylene (mLLDPE) and two outer layers made of high-density polyethylene (HDPE) and bonded to the central layer and surrounding a central layer. The HDPE content of the polyethylene film constitutes at least 50 vol %, preferably at least 80 vol %, and the two outer layers together are at least as thick as the central layer. The polyethylene film is stretched in at least one direction.

### TECHNICAL FIELD

The present invention relates to a recyclable polyethylene film with a high rigidity and heat resistance as well as a sufficiently high toughness.

### BACKGROUND

The usual packaging films made of plastic today are film laminates comprising a variety of layers (depending on application and function), for example, polyolefins such as polyethylene (PE) or polypropylene (PP), often combined with polyethylene terephthalate (PET) as the outer printed layer. Usually layers of different plastics are combined. Laminates of plastic layers with other materials such as aluminum or paper are also conceivable. Packaging is essentially also always produced with printing that is visible on the outside. The printing is applied to a layer of the film laminate that is suitable for printing, for example, a layer of biaxially stretched polypropylene (BO-PP) or polyethylene terephthalate (BO-PET).

In most cases, an inline printing process such as the gravure printing process or the inline flexographic printing process is used as the printing process for high-quality packaging materials. In an inline printing process, the individual printing units are separated from one another and the film sheet to be printed passes through a dryer and multiple deflecting rollers, in order to lengthen the drying length, before each application of the next ink. With certain films, in particular PE films, however, this leads to problems with the register accuracy and/or to unacceptable print images. PE films and PE film laminates are therefore usually printed by flexographic printing processes in satellite configuration on so-called central printing cylinder machines. In such machines the film sheet to be printed is held between the individual printing units on a central cylinder and only then is it dried. Also a possible intermediate drying after one application of ink is carried out on the central cylinder wherein the film sheet is also held on the central cylinder during drying, but this does not usually allow complete drying between the printing units because the drying length is very short. Therefore, the print quality in a flexographic printing process in satellite configuration is not as high as it would be in the inline printing process. But the thereby achievable register accuracy is high enough even when using PE films, for example for diaper films.

With high-quality packaging laminates, the packaging manufacturers usually require printing of the film laminate by an inline printing process, for example by a gravure printing process or by a (UV) flexographic inline printing process, because of the print image which is thereby achievable. Therefore, a PET or PP film sheet is used as the printed film sheet in such film laminates, which are then laminated with a sealable material that is capable of sealing at low temperatures, such as PE films, to form the film laminate.

The film laminates for the packaging industry should naturally be as thin as possible for cost reasons. This means that the individual film layers should be designed to be as thin as possible, depending on their function. An outer layer which carries only the print image should be as thin as possible. According to the state of the art today, for example, printed PET film sheets with a layer thicknesses of only 12 μm are used.

However, such film laminates that are used in the packaging industry are difficult to recycle because of the different materials they contain because the materials are difficult to separate. Therefore, there is a discernible trend to use so-called monolaminates in the packaging industry, i.e., film laminates made of (essentially) only one material. In particular, a monolaminate of polyethylene (PE) is of interest here because polyethylene is the most widely used sealing medium in the packaging industry. Film laminates consisting of a main material, for example, PE and containing only small amounts of any other material are also used as monolaminates. Such film laminates are still regarded as monolaminates in the sense of the present invention and are relatively easy to recycle.

The problem with a monolaminate of polyethylene is that PE films with an industrially relevant thickness of less than 40 μm can be printed only to a limited extent or not at all in the required quality when using the inline printing systems, and in particular not by gravure printing process or a flexographic inline printing process. Thus, it has not yet been possible to produce such polyethylene monolaminates that are printed by the gravure printing process and can be used for the packaging industry.

DE 10 2005 003 922 A1 discloses a film laminate of a stretched HDPE printing film and an LDPE backing film, wherein the printed film is printed. The backing film should be significantly thicker than the printing film.

### SUMMARY

It is an object of the present invention to provide a polyethylene film that can be printed by using an inline printing process, in particular the gravure printing process or flexographic inline printing process, that can be used in the packaging industry and that is easy to recycle.

This object is achieved with a polyethylene film consisting of at least 80% polyethylene material and max. 20% compatible polyolefin material, wherein the polyethylene film has a central layer of linear low-density polyethylene (LLDPE) and/or metallocene linear low-density polyethylene (mLLDPE) and two outer layers made of high-density polyethylene (HDPE) surrounding the central layer and bonded to it, wherein the amount of HDPE in the polyethylene film constitutes at least 50 vol %, preferably at least 80 vol %, and the two outer layers together are at least the same thickness as the central layer, and wherein the polyethylene film is stretched in it at least one direction. With such a film, an adequate sheet rigidity of preferably at least 10 N/mm at 70° C. is achieved, which is sufficient for high quality printing with an inline printing process such as the gravure printing process or the flexographic inline printing process. With such a film, the register error in printing can be kept within the limits that are tolerable for the packing industry. The haze value of the film is reduced by stretching of the polyethylene film. In addition, the polyethylene film according to the invention has a sufficient toughness and heat resistance.

An outer layer is preferably max. 50% thicker than the other outer layer in order to prevent excessive curling of the polyethylene film. Ideally the two outer layers have the same thickness.

Polyethylene film thicknesses of less than 40 μm, preferably less than 30 μm, most especially preferably less than 20 μm can be achieved due to the design of the polyethylene film, which makes this film usable for the packaging industry in particular.

To achieve the required rigidity, a stretching ratio of the polyethylene film greater than 1:2, preferably greater than 1:3 and in particular greater than 1:4 is advantageous.

To further improve the heat resistance of the polyethylene film in comparison to an outer layer of pure HDPE, it is advantageous if a heat resistive polyolefin material is present in at least one outer layer. The heat resistive polyolefin material can be applied as a coextruded layer to the outer layer or may also be blended into the outer layer, whereas also both are also possible. So as not to impair the recyclability of the stretched PE film and the PE film laminate produced from it, the total amount of added polyolefin should not be more than 20 percentage per weight.

If the polyethylene film has a haze value of less than 10, preferably less than 8, especially preferably less than 5, then the polyethylene film in the film laminate can also be used with backside printing (i.e., with printing inside the film laminate) because the film has sufficient transparency. The haze value can also be improved via the stretching ratio of the polyethylene film.

Another object of the invention is to provide a film laminate with a polyethylene film according to the invention, and in particular a monolaminate of polyethylene. Such a film laminate is characterized in that the polyethylene film according to the invention is laminated onto a backing layer, in particular one made of polyethylene.

It is thus possible for the first time to produce a recyclable monolaminate of polyethylene for the small thicknesses required in the packaging industry in which a PE layer is printed by an inline printing process.

It is most especially advantageous with the film laminate if the outer layer of the stretched and printed PE film is coated with a heat resistive polyolefin material. This therefore relates to the side arranged facing away from the backing layer of polyethylene as a sealing layer, i.e., the outer side of the packaging laminate which has the print image. Thus, because of the increased heat resistance of the polyethylene film, the sealing temperature in processing, in particular in a packaging process, can be increased. This improves the processability of the film laminate.

### BRIEF DESCRIPTION OF THE DRAWINGS

The present invention is explained below in greater detail with reference to FIGS. 1 and 2 which show, schematically and without restriction, advantageous embodiments of the invention, and in which:

FIG. 1 shows a polyethylene film according to the invention and;

FIG. 2 shows a film laminate according to the invention with a polyethylene film.

### DETAILED DESCRIPTION

The present invention is described in greater detail below, wherein reference is made in the following description to certain properties of a plastic film which are measured and/or are defined as follows. In doing so the measurement methods defined in the well-known standards of the ASTM (American Society for Testing and Materials)—abbreviated ASTM standard—are used.

Modulus of Elasticity or E Modulus:

This is Measured According to ASTM D882, wherein as E modulus (in MPa) the 2% secant modulus in the machine direction as defined in the aforementioned standard is used. To measure the E modulus, a sample of material of the film sheet to be measured is used with a measurement length of 100 mm and a width of 25 mm, and the E modulus is measured at a test speed of 10 mm/min.

The E modulus at a certain temperature is then the measured E modulus at this temperature. To do so the measurement is performed at the desired temperature.

The E modulus in the machine direction is the E modulus measured on a stretched film wherein the machine direction corresponds to the direction of stretching of the film. However, this is the case only with film drawn in one direction but not with biaxially drawn films. In this case the machine direction is the direction of conveyance of the film sheet.

Turbidity (Haze):

The haze value is a measure of the turbidity of transparent samples. The method for measuring the haze value is described in the ASTM D 1003 standard.

Sheet Rigidity:

Sheet rigidity (in N/mm) is understood to be the product of the E modulus as defined above and the thickness of the measured film sheet.

A polyethylene film 1 according to the invention with a layer thickness of less than 40 μm must have a sheet rigidity of at least 10 N/mm at 70° C. in order to be able to print the film with an adequate print quality even in an inline printing process. A layer thickness of the polyethylene film 1 in the range of 15 to 40 μm is aimed for in the packaging industry. Because of this sheet rigidity, the polyethylene film 1 is sufficient rigid at a temperature of 70° C. to be printable with an inline printing process, such as the gravure printing process or the flexographic printing process, for example. Then it is possible to ensure a register accuracy of at least ±0.2 mm, which is sufficient for good printing results. If the sheet rigidity were lower, then the achievable register error in printing would be much greater, which would result in inadequate printing results when printed with an inline printing process. Register error occurs in particular because in an inline printing process (such as the gravure printing process or the flexographic inline printing process) with at least two separate printing units, each printing ink is applied individually and after each application of printing ink a drying step at temperatures of about 70° C. follows. The polyethylene film 1 is also deflected repeatedly guided through the dryer in each drying step to increase the length of the drying path. The polyethylene film 1 is therefore heated during printing. If the sheet rigidity is too low at this temperature, the polyethylene film 1 will expand during printing, so that the print image can be shifted in successive ink applications. This results in the register error.

Furthermore, the polyethylene film 1 should have a sufficiently high heat resistance, so that a film laminate produced with it can be easily sealed. In processing the film laminate, for example, in a packing operation, the aim is to reach high sealing jaw temperatures in order to improve the processability and/or the melting of the sealing layer of the film laminate polyethylene film 1, for example, to produce bag packaging. The higher the possible sealing temperature, the better and more rapidly the polyethylene film 1 can be processed, which can be achieved with a sufficiently high heat resistance of the polyethylene film 1. The heat resistance essentially indicates the temperature above which the polyethylene film 1 begins to melt.

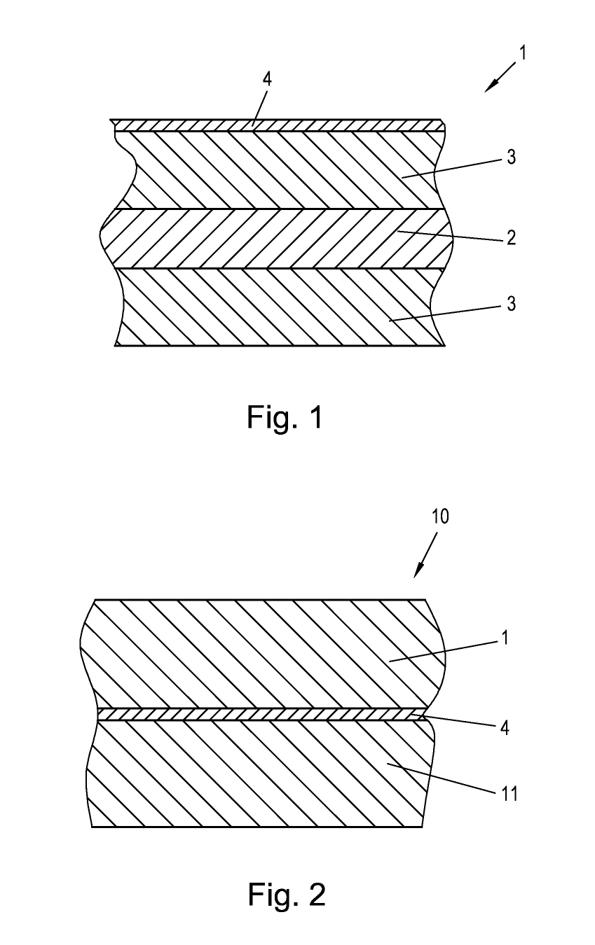

The polyethylene film 1 according to the invention has an HDPE (high-density polyethylene) content of at least 50 vol % (percent by volume) to increase the sheet rigidity of the polyethylene film 1 and its heat resistance. In this way, the required properties of the polyethylene film 1 can be achieved. However, the total HDPE content of the polyethylene film 1 and also the arrangement of the HDPE within the layers of the polyethylene film 1 are important. According to the invention, the polyethylene film 1 is implemented multi-layered (FIG. 1) with at least one central layer 2 made mainly of LLDPE (linear low-density polyethylene) or mLLDPE (metallocene linear low-density polyethylene) (or a mixture thereof). The central layer 2 contains at least 80 vol % LLDPE or mLLDPE, while the remaining amounts may consist of other polyolefin materials, in particular a polyethylene, such as HDPE. The central layer 2 is surrounded on each of the two sides by an outer layer 3 of HDPE which serve to improve the toughness of the polyethylene film 1. The two outer layers 3 together are at least as thick as the central layer 2. To prevent (excessive) curling of the polyethylene film 1, one of the two outer layers 3 is preferably max. 50% thicker than the other outer layer 3. Ideally a symmetrical layer structure with two outer layers 3 of the same thickness is used. Thus, for example, a 1/1/1 layer structure of the polyethylene film 1 with HDPE/LLDPE or mLLDPE/HDPE or a 2/1/2 layer structure with HDPE/LLDPE or mLLDPE/HDPE would thus fall under this definition. A possible asymmetrical layer structure would be 3/1/2 with HDPE/LLDPE or mLLDPE/HDPE, for example.

The HDPE content in the multilayer polyethylene film 1 is at least 50 vol % to achieve the required sheet rigidity and heat resistance. A small amount of another polyolefin material, for example, 5% to 10% LLDPE C8, may also be added to one or both HDPE outer layers 3, to further improve the toughness.

The multilayer polyethylene film 1 can be produced by coextrusion of the individual layers. The central layer 2 could itself in turn be constructed of multiple layers. Likewise, an outer layer 3 may also be constructed of multiple layers.

To achieve the required sheet rigidity with the desired small layer thicknesses of the polyethylene film 1 of less than 40 μm more easily, the polyethylene film 1 is additionally stretched in at least one direction. Stretching of the polyethylene film 1 has the additional advantageous effect that the haze value of the polyethylene film is thereby reduced. The stretching ratio of the stretched polyethylene film 1 is preferably greater than 1:2, in particular greater than 1:3 and most especially advantageously greater than 1:4.

At least one of the two outer layers 3 is printed using an inline printing process such as the gravure printing process or the inline flexographic printing process (printing layer 4 in FIG. 1).

The printability of a polyethylene film 1 according to the invention for the packaging industry is confirmed in the following comparative example:

| | Polyethylene film | | | |
|---|---|---|---|---|
| | Film 1 | | | |
| | 50% LDPE, | Film 2 | Film 3 | Film 4 |
| | 50% LLDPE | 40% HDPE, | 50% HDPE, | 80% HDPE, |
| | coextruded | 60% LLDPE | 50% LLDPE | 20% LLDPE |
| | blend the | coextruded | coextruded | coextruded |
| | same in all | HDPE in | HDPE in | HDPE in |
| | layers | outer layers | outer layers | outer layers |
| Layer structure | 1/1/1 | 1/3/1 | 1/2/1 | 2/1/2 |
| Stretching ratio | none | 1:6 | 1:6 | 1:5 |
| Thickness [μm] | 70 | 25 | 25 | 20 |
| E modulus at | 75 | 350 | 480 | 750 |
| 70° C. [MPa] | | | | |
| Sheet rigidity | 5.25 | 8.75 | 12 | 15 |
| [N/mm] | | | | |
| Register | ±0.7 | ±0.5 | ±0.15 | ±0.05 |
| accuracy [m] | | | | |

In the case of the stretched films 2, 3 and 4 the E modulus is the E modulus in machine direction.

In the above table it is discernible, that the polyethylene film 1 with a HDPE amount of greater than 50% and with adequate stretching (film 3), due to the sheet rigidity thereby achieved, is rigid enough even at a thickness of less than 40 μm to be printable with the required register accuracy in inline printing presses (for example, gravure printing process or flexographic inline printing process). Without stretching, also films 3 and 4 would not be rigid enough for an inline printing process. Because of the HDPE content of at least 50 vol %, films 3 and 4 also have a good heat resistance.

A film disclosed in DE 10 2005 003922A1 made solely from HDPE would also be rigid enough as a printing medium for printing and heat resistive, but would not be tough enough for use as a packaging laminate and would tend to splice in the direction of stretching. However, all of these contradictory properties can be combined by using a film structure according to the invention.

The heat resistance of the polyethylene film 1 can be further improved if an outer layer 3 is supplemented with a compatible heat resistive polyolefin material such as polypropylene (PP) or a cycloolefin copolymer (COC), for example. This heat resistive material may be extruded as a thin layer onto the outer layer 3 on at least one side of the polyethylene film 1. However, it is also conceivable to blend the heat resistive material into the at least one outer layer 3 made of a HDPE. Doing both at the same time is also conceivable, i.e., coextruded layer and blending. If, in addition to polyethylene, other heat resistive polyolefins (in the various types) are also used in the polyethylene film 1, then the amount of polyethylene should constitute at least 80 vol % of the polyethylene film 1 in order not to have a negative effect on the recyclability of the polyethylene film 1. The remaining 20 vol % is formed by a compatible polyolefin material.

A film laminate 10 according to the invention, in particular for the packaging industry, with a polyethylene film 1 as described above, as shown in FIG. 2, is produced as follows, for example:

First, a polyethylene film 1 according to the invention, having a thickness of less than 40 μm, preferably less than 30 μm, in particular preferably less than 20 μm, and with a sheet rigidity of at least 10 N/mm at 70° C. is produced. This polyethylene film 1 is printed on one side by means of a gravure printing process or is printed on at least one side in another inline printing process, for example, the flexographic inline printing process. This can take place with sufficient accuracy because of the rigidity achieved.

The polyethylene film 1 printed in this way is then laminated onto a backing film 11, preferably an unstretched backing polyethylene film, to produce the film laminate 10. If the backing film 11 is made of polyethylene, then a monomaterial laminate is produced. The printed side with the print layer 4 of the printed polyethylene film 1 may also be facing to the inside, i.e., to the backing film 11, if the turbidity of the printed polyethylene film 1 is sufficiently low. This may be assumed if the haze value of the printed polyethylene film 1 is lower than 10, preferably lower than 8, especially preferably lower than 5.

A backing polyethylene film of the film laminate 10 forms a sealing layer. If the polyethylene film 1 according to the invention contains an additional heat resistive material in an outer layer 3 (as an admixture or as a separate coextruded layer), then this outer layer 3 is preferably arranged so that it faces away from the backing polyethylene film in order to be able to utilize the increased heat resistance.

Such haze values and also high rigidity values with thin packaging films can be achieved with polyethylene films 1 having an HDPE content, if a polyethylene film stretched in at least one direction is used as the printed polyethylene film 1. Then the otherwise turbid HDPE will be mostly transparent.

The printed polyethylene film 1 according to the invention may of course also be laminated to other layers or additional layers. For example, an intermediate aluminum layer by be provided as an aroma barrier in the film laminate. Likewise, the printed polyethylene film 1 or the backing film 11 may also be metalized or coated with a barrier coating. The printed polyethylene film 1 according to the invention could also be laminated to any other backing layer, depending on the application, wherein the backing layer itself may be embodied with multiple layers. However, because of the printing, the polyethylene film 1 according to the invention is preferably an outer layer of the film laminate 10 thereby produced.

The typical total thickness of the film laminate 10 according to the invention for the packaging industry is 40-120 μm. In the case of a monolaminate, a total thickness in the range of 30-150 μm is the goal.

1. A recyclable polyethylene film of at least 80% polyethylene material and max. 20% compatible polyolefin material with a thickness of less than 40 μm, wherein the polyethylene film has a central layer of linear low-density polyethylene (LLDPE) and/or metallocene linear low-density polyethylene (mLLDPE) and two outer layers made of high-density polyethylene (HDPE) and bonded to the central layer and surrounding the central layer wherein the HDPE content of the polyethylene film constitutes at least 80 vol %, and the two outer layers together are at least four times as thick as the central layer and wherein the polyethylene film is stretched in at least one direction.

2. The recyclable polyethylene film according to claim 1, wherein an outer layer is max. 50% thicker than the other outer layer.

3. The recyclable polyethylene film according to claim 1, wherein the thickness of the polyethylene film is less than 30 μm.

4. The recyclable polyethylene film according to claim 1, wherein an outer layer is printed by an inline printing process.

5. The recyclable polyethylene film according to claim 1, wherein the stretching ratio of the polyethylene film is greater than 1:2.

6. The recyclable polyethylene film according to claim 1, wherein a heat resistive polyolefin material is present in a maximum amount of 20 vol % in at least one outer layer.

7. The recyclable polyethylene film according to claim 6, wherein the heat resistive polyolefin material is applied at least partially as a coextruded layer to the outer layer.

8. The recyclable polyethylene film according to claim 6, wherein the heat resistive polyolefin material is blended at least partially into the outer layer.

9. The recyclable polyethylene film according to claim 1, wherein the polyethylene film has a haze value of less than 10.

10. A film laminate with at least one backing layer and a recyclable polyethylene film bonded thereto according to claim 1.

11. The film laminate according to claim 10, wherein the backing layer is produced from polyethylene.

12. The film laminate according to claim 10, wherein the printed outer layer is arranged so that it faces the backing layer.

13. The film laminate according to claim 1, wherein the outer layer with a heat resistive polyolefin material is arranged facing away from the backing layer.

14. The recyclable polyethylene film according to claim 1, wherein the stretching ratio of the polyethylene film is greater than 1:3.

15. The recyclable polyethylene film according to claim 1, wherein the stretching ratio of the polyethylene film is greater than 1:4.

16. The recyclable polyethylene film according to claim 1, wherein the polyethylene film has a haze value of less than 8.

17. The recyclable polyethylene film according to claim 1, wherein the polyethylene film has a haze value of less than 5.

18. The film laminate according to claim 11, wherein the printed outer layer is arranged so that it faces the backing layer.
